(19) United States
(12) Patent Application Publication
(10) Pub. No.: US 2025/0307757 A1
(43) Pub. Date: Oct. 2, 2025

(54) DELIVERY PLANNING APPARATUS AND DELIVERY PLANNING METHOD

(71) Applicant: TOYOTA JIDOSHA KABUSHIKI KAISHA, Toyota-shi (JP)

(72) Inventor: Keisuke Morisaki, Toyota-shi (JP)

(73) Assignee: TOYOTA JIDOSHA KABUSHIKI KAISHA, Toyota-shi (JP)

(21) Appl. No.: 19/001,437

(22) Filed: Dec. 25, 2024

(30) Foreign Application Priority Data
Apr. 1, 2024 (JP) 2024-059051

(51) Int. Cl. G06Q 10/0835; G01C 21/34

(52) U.S. Cl. CPC G06Q 10/08355; G01C 21/3461; G01C 21/3469

(57) ABSTRACT

The delivery plan server is a device that plans delivery by a plurality of delivery vehicles, and includes a storage unit that stores delivery information including location information of delivery destinations of the plurality of packages, and a CPU. The delivery vehicle includes a first-type vehicle (BEV, FCEV) and a second-type vehicle (ICE vehicle, PHEV) that is more exhausted or noisy than the first-type vehicle. CPU creates a plurality of delivery routes for respectively delivering a plurality of groups of packages from the position information included in the delivery information stored in the storage unit, and assigns the first-type vehicles to the second-type routes including a large number of areas in which emission or noise is strictly regulated as compared with the first-type routes among the created plurality of delivery routes.

### CROSS-REFERENCE TO RELATED APPLICATION

This application claims priority to Japanese Patent Application No. 2024-059051 filed on Apr. 1, 2024, incorporated herein by reference in its entirety.

### BACKGROUND

### 1. Technical Field

The present disclosure relates to a delivery planning apparatus and a delivery planning method, and more particularly to a delivery planning apparatus that plans delivery by a plurality of vehicles and a delivery planning method of a delivery planning apparatus that plans delivery by a plurality of vehicles.

### 2. Description of Related Art

Conventionally, there has been a technique of assigning electrified vehicles to delivery routes passing through charging facilities in order to cause the electrified vehicles to stop by at the charging facilities to be charged during delivery in the process of delivery by the electrified vehicles that can be charged, such as battery electric vehicles (BEVs) and plug-in hybrid electric vehicles (PHEVs) (see Japanese Unexamined Patent Application Publication No. 2023-133750 (JP 2023-133750 A, for example).

### SUMMARY

Vehicles with different power sources have different characteristics such as degrees of exhaust gas emission and degrees of noise generation. Therefore, there is room for improvement in assigning of vehicles in consideration of characteristics of vehicles to each delivery route.

The present disclosure was made in order to solve the above-described problem, and an object thereof is to provide a delivery planning apparatus and a delivery planning method capable of appropriately assigning vehicles in accordance with delivery routes.

A delivery planning apparatus according to the disclosure is a delivery planning apparatus that plans delivery by a plurality of vehicles, and includes: a storage unit that stores delivery information including location information of delivery destinations of a plurality of packages; and
a processor.
   The vehicle includes first-type vehicles and second-type vehicles that generate more exhaust or noise than the first-type vehicles.
   The processor creates a plurality of delivery routes to deliver each of a plurality of groups of packages from the location information included in the delivery information stored in the storage unit, and assigns the first-type vehicles to second-type routes that include more areas where exhaust or noise is strictly restricted than first-type routes from among the plurality of created delivery routes.

According to such a configuration, the first-type vehicles are assigned to the second-type routes from among the plurality of delivery routes created from the location information included in the delivery information. The second-type routes include more areas where exhaust or noise is strictly restricted as compared with the first-type routes. The first-type vehicles generate less exhaust or noise than the second-type vehicles. As a result, it is possible to provide a delivery planning apparatus capable of appropriately assigning vehicles in accordance with delivery routes.

The processor may assign the second-type vehicles to the first-type routes. According to such a configuration, the second-type vehicles that generate a relatively large amount of exhaust or noise are assigned to the first-type routes that include relatively small numbers of areas where exhaust or noise is strictly restricted. As a result, it is possible to appropriately assign vehicles in accordance with delivery routes.

The second-type vehicles include third-type vehicles and fourth-type vehicles that generate more exhaust or noise than the third-type vehicles.

In a case where the first-type vehicles to be assigned to the second-type routes are insufficient, the processor may assign the first-type vehicles, the third-type vehicles, and the fourth-type vehicles in order from routes that include more areas where exhaust or noise is strictly restricted from among the second-type routes.

According to such a configuration, the first-type vehicles, the third-type vehicles, and the fourth-type vehicles are assigned in order from routes that include more areas where exhaust or noise is strictly restricted from among the second-type routes in the case where the first-type vehicles to be assigned to the second-type routes are insufficient. The second-type routes include relatively large numbers of areas where exhaust or noise is strictly restricted. The first-type vehicles generate a relatively small amount of exhaust or noise. The third-type vehicles generate more exhaust or noise than the first-type vehicles. The fourth-type vehicles generate more exhaust or noise than the third-type vehicles. As a result, it is possible to appropriately assign vehicles in accordance with delivery routes.

The processor may assign the first-type vehicles, the third-type vehicles, and the fourth-type vehicles in order from routes that include more areas where exhaust is strictly restricted relative to areas where noise is strictly restricted from among the second-type routes.

According to such a configuration, the first-type vehicles, the third-type vehicles, and the fourth-type vehicles are assigned in order from routes including more areas where exhaust is strictly restricted relative to areas where noise is strictly restricted from among the second-type routes. The third-type vehicles generate more exhaust or noise than the first-type vehicles. The fourth-type vehicles generate more exhaust or noise than the third-type vehicles. As a result, it is possible to appropriately assign vehicles in accordance with delivery routes.

According to another aspect of the present disclosure, a delivery planning method is a method of planning delivery by a delivery planning apparatus that plans delivery by a plurality of vehicles.

The delivery planning apparatus includes
a storage unit that stores delivery information including location information of delivery destinations of a plurality of packages, and a processor.
   The vehicle includes first-type vehicles and second-type vehicles that generate more exhaust or noise than the first-type vehicles.
   The delivery planning method includes, by a processor:
creating a plurality of delivery routes to deliver each of a plurality of groups of packages from the location information included in the delivery information stored in the storage unit; and
assigning the first-type vehicles to second-type routes that include more areas where exhaust or noise is strictly restricted than first-type routes from among the plurality of created delivery routes.

According to such a configuration, it is possible to provide a delivery planning method capable of appropriately assigning vehicles in accordance with delivery routes.

According to the present disclosure, it is possible to provide a delivery planning apparatus and a delivery planning method capable of appropriately assigning vehicles in accordance with delivery routes.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an overall configuration of a delivery planning system 1 according to an embodiment of the present disclosure;

FIG. 2 is a schematic diagram for explaining delivery of a package in the delivery planning system 1 according to this embodiment;

FIG. 3 is a flowchart illustrating an outline of a flow of delivery plan processing executed by the delivery plan server according to the first embodiment;

FIG. 4 is a flowchart illustrating an outline of a flow of delivery plan processing executed by the delivery plan server according to the second embodiment;

FIG. 5 is a flow chart illustrating an outline of a flow of a delivery plan process executed by the delivery plan server according to the third embodiment; and

FIG. 6 is a flowchart illustrating an outline of a flow of delivery plan processing executed by the delivery plan server according to the fourth embodiment.

### DETAILED DESCRIPTION OF EMBODIMENTS

Hereinafter, embodiments of the present disclosure will be described in detail with reference to the drawings. It should be noted that the same or corresponding portions in the drawings are designated by the same reference signs and repetitive description will be omitted.

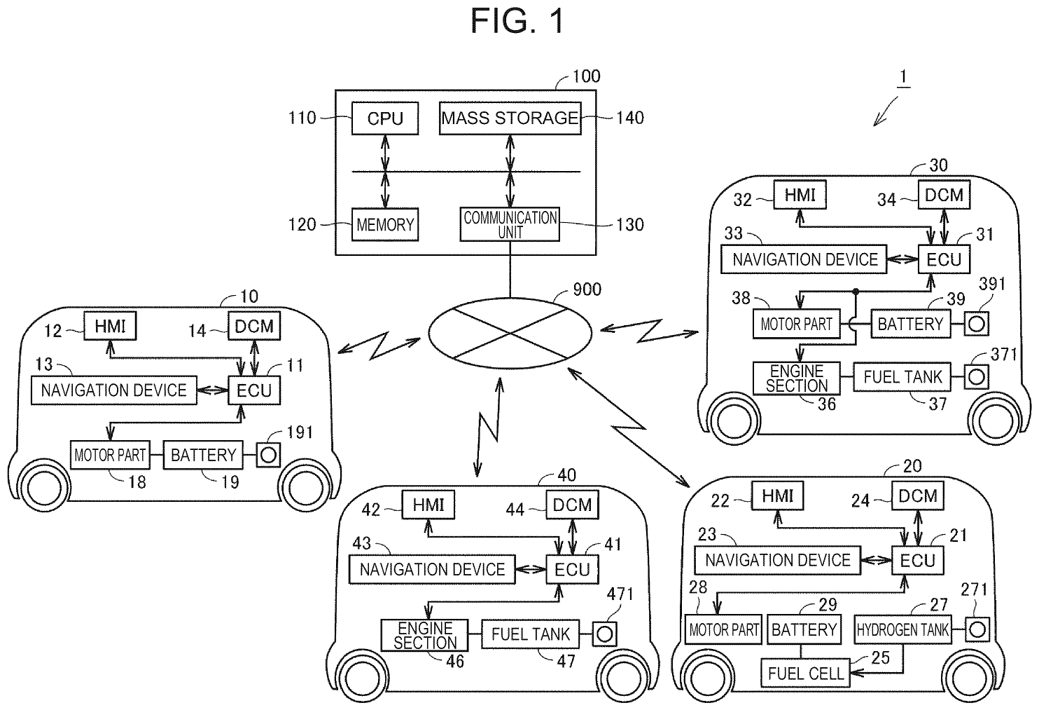

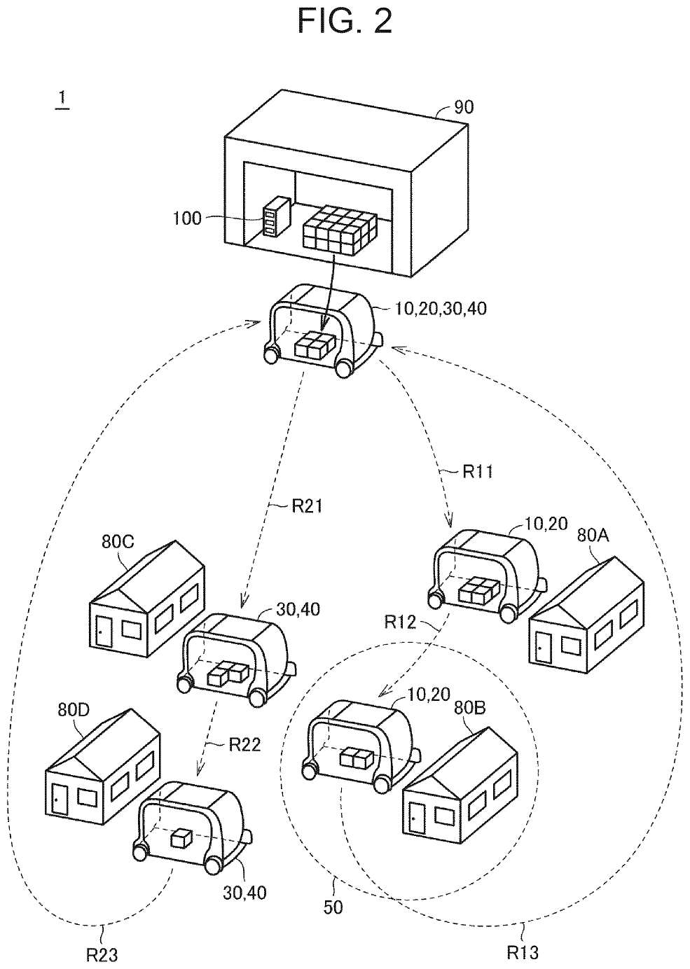

FIG. 1 is a diagram schematically illustrating an overall configuration of a delivery planning system 1 according to an embodiment of the present disclosure. FIG. 2 is a schematic diagram for explaining delivery of a package in the delivery planning system 1 according to this embodiment. Referring to FIGS. 1 and 2, the delivery planning system 1 includes a delivery plan server 100 and a delivery vehicle that delivers a package. The delivery vehicle may be an autonomous vehicle or a vehicle driven by a user. As illustrated in FIG. 2, a package scheduled to be delivered from a delivery destination AI to 80D by R23 10 from a R13, R21 through a delivery route R11 is loaded into a delivery vehicle at a delivery base 90. Thereafter, the delivery vehicles travel from the delivery route R11 to R13, R21 through R23 and deliver the package from the delivery destination 80A to 80D.

The delivery vehicles include, in this embodiment, a BEV 10, a fuel cell electric vehicle (FCEV) 20, a PHEV 30, and an internal combustion locomotive 40. An internal combustion locomotive is hereinafter referred to as an “Internal Combustion Engine (ICE) vehicle”.

The delivery plan server 100 is a device that plans delivery by a plurality of delivery vehicles, and is installed in, for example, the delivery base 90. The location where the delivery plan server 100 is installed may be another location, such as an office of a delivery company. The delivery plan server 100 includes a Central Processing Unit (CPU) 110, a memory 120, a communication unit 130, and a mass storage device 140.

The memories 120 include Random Access Memory (RAM) and Read Only Memory (ROM). The communication unit 130 can communicate with an external device such as a delivery vehicle via the communication network 900, transmits data from CPU 110 to the external device, and delivers data from the external device to CPU 110. The mass storage device 140 is composed of Hard Disk Drive (HDD) or Solid State Drive (SSD), and stores programs and data used in CPU 110. CPU 110 executes a predetermined process defined by the program in accordance with the program and the data stored in the memory 120 or the mass storage device 140 and the data inputted from the external device to the 30 communication unit 130. CPU 110 causes the memory 120 or the mass storage device 140 to store the executed data, or causes the communication unit 130 to transmit the executed data to an external device.

BEV 10 includes an Electronic Control Unit (ECU) 11, a Human Machine Interface (HMI) 12, a navigation device 13, a Data Communication Module (DCM) 14, a motor unit 18, a battery 19, and a power supply port 191.

The battery 19 stores electric power used for traveling of BEV 10, and is constituted by, for example, a lithium-ion battery. However, the present disclosure is not limited thereto, and the battery 19 may be formed of another type of battery, for example, a nickel metal hydride battery or an all-solid-state battery. The battery 19 stores electric power supplied from the power supply port 191.

ECU 11 includes CPU and memories. It includes Random Access Memory (RAM) and Read Only Memory (ROM) and stores programming and data used in CPU. CPU executes a predetermined process defined by the program in accordance with the program and the data stored in the memory and the data inputted from the outside, and stores the data of the executed result in the memory or outputs the data to the outside.

HMI 12 is provided in the vicinity of the driver's seat of BEV 10, and receives information inputted from the user and outputs the information to ECU 11, or displays or audibly notifies the user of information from ECU 11. HMI 12 includes, for example, a touch panel display.

DCM 14 is a module for communicating with an external device such as the delivery plan server 100 via the communication network 900, and transmits data from ECU 11 to the external device and delivers data from the external device to ECU 11.

The navigation device 13 includes a Global Positioning System (GPS). GPS detects the position of BEV 10. The navigation device 13 searches for a delivery route that goes around the delivery destination using the position information detected by GPS, displays the delivery route on an HMI 12, or guides the delivery route to the destination. When the vehicle is a vehicle driven by the user, the user drives BEV 10 and delivers the package according to the delivery route displayed on HMI 42 by the navigation device 13. When the vehicle is an autonomous driving vehicle, ECU 11 autonomously drives BEV 10 in accordance with guidance for traveling along R23 from R13, R21 through the delivery route R11 by the navigation device 13, and delivers the package from the delivery destination 80A to each 80D.

The motor unit 18 includes a motor generator and an inverter that drives the motor generator by using electric power from the battery 19 and charges the battery 19 with regenerative electric power from the motor generator.

FCEV 20 includes a ECU 21, a HMI 22, a navigation device 23, a DCM 24, a motor unit 28, a battery 29, a fuel cell 25, a hydrogen-tank 27, and a supply port 271. ECU 21, HMI 22, the navigation device 23, DCM 24, the motor unit 28, and the battery 29 are the same as those of the navigation device 13, DCM 14, the motor unit 18, and the battery 19 in ECU 11, HMI 12 of the above-described BEV 10, respectively, and therefore will not be described repeatedly.

The hydrogen tank 27 stores hydrogen supplied from the supply port 271. The fuel cell 25 generates electricity by electrochemically reacting hydrogen supplied from the supply port 271 with oxygen in the atmosphere. The fuel cell 25 stores the generated electric power in the battery 29 or directly supplies the electric power to the motor unit 28.

PHEV 30 includes a ECU 31, a HMI 32, a navigation device 33, a DCM 34, a motor unit 38, a battery 39, a power supply port 391, an engine unit 36, a fuel-tank 37, and a supply port 371. ECU 31, HMI 32, the navigation device 33, DCM 34, the motor unit 38, the battery 39, and the power supply port 391 are the same as ECU 11, HMI 12, the navigation device 13, DCM 14, the motor unit 18, the battery 19, and the power supply port 191 in the above-described BEV 10, respectively, and therefore will not be described repeatedly.

The fuel tank 37 stores fuel (e.g., gasoline, light oil) supplied from the supply port 371. The engine unit 36 includes an engine that generates power by burning fuel in an internal combustion engine, and a transmission that decelerates the rotational speed of the power output from the engine. Further, the motor unit 38 generates regenerative electric power by the power output from the engine unit 36, and charges the battery 39.

ICE vehicle 40 includes a ECU 41, a HMI 42, a navigation device 43, a DCM 44, an engine unit 46, a fuel-tank 47, and a supply port 471. ECU 41, HMI 42, the navigation device 43, and DCM 44 are the same as those of ECU 11, HMI 12, the navigation device 13, and DCM 14 of BEV 10 described above, respectively, and therefore will not be described repeatedly. The engine unit 46, the fuel tank 47, and the supply port 471 are the same as the engine unit 36, the fuel tank 37, and the supply port 371 of the above-described PHEV 30, respectively, and therefore, the overlapping explanation will not be repeated.

In the above-described configuration, there is a technique of assigning an electrified vehicle to a delivery route through a charging facility in order to stop an electrified vehicle being delivered to the charging facility and charge it during delivery by a chargeable electrified vehicle such as a BEV 10 and a PHEV 30. Vehicles with different power sources have different characteristics such as degrees of exhaust gas emission and degrees of noise generation. Therefore, there is room for improvement in assigning of vehicles in consideration of characteristics of vehicles to each delivery route.

Thus, CPU 110 of the delivery plan servers 100 is:

A plurality of delivery routes for respectively delivering a plurality of groups of packages are created from the location information included in the delivery information stored in the memory 120 or the mass storage device 140,
A first-type vehicle having less exhaust gas or noise compared to a second-type vehicle is assigned to a second-type route including a large number of regions in which exhaust gas or noise is strictly regulated compared to a first-type route among a plurality of created delivery routes. The second-type vehicle is, for example, PHEV 30, ICE vehicle 40. The first-type vehicles are, for example, BEV 10, FCEV 20.

Thus, the first-type vehicle having less exhaust gas or noise compared to the second-type vehicle is assigned to the second-type route. The second-type route includes a large number of regions in which exhaust gas or noise is strictly regulated as compared with the first-type route among the plurality of delivery routes created from the position information included in the delivery information. As a result, it is possible to appropriately assign vehicles in accordance with delivery routes.

Here, the exhaust gas is exhaust gas emitted by the combustion of fuel from the engine unit 36 of PHEV 30 and the engine unit 46 of ICE vehicle 40. The amount of exhaust gas is the amount of toxic substances such as NOx in exhaust gas, the amount of particulate matter in exhaust gas, or the amount of CO2 in exhaust gas. Particulate matter in the exhaust is hereinafter referred to as “Particulate Matters (PM)”. The amount of exhaust may be indicated by the amount of harmful substances emitted per unit time in the operating state according to the predetermined condition of the vehicle. The amount of emissions may be represented as a mean or median of PM emissions or CO2 emissions. Emission regulations are regional regulations.

The noise is the noise generated from the engine unit 36 of PHEV 30 and the engine unit 46 of ICE vehicle 40. The amount of noise is a magnitude of noise generated, and may be represented by, for example, a unit dB, and may be represented by a representative value such as an average value or a median value of noise magnitudes in a predetermined driving condition of the vehicle. Noise regulations are regional regulations.

In FIG. 2, the regulated area 50 is an area where exhaust and noise are regulated, a residential area, or a vehicle regulating area for nature protection.

### First Embodiment

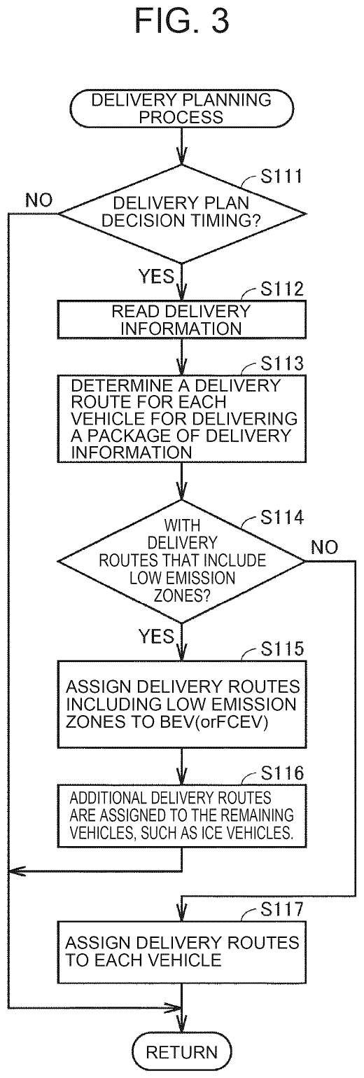

FIG. 3 is a flowchart schematically illustrating a flow of delivery plan processing executed by the delivery plan server 100 according to the first embodiment. Referring to FIG. 3, the delivery plan processing is called from the higher-level processing at predetermined intervals by CPU 110 of the delivery plan server 100 and is executed. CPU 110 of the delivery plan server 100 determines whether or not the present is the timing for determining the delivery plan (S111). When it is determined that it is not the delivery plan determination timing (NO in S111), CPU 110 returns the processing to be executed to the processing of the upper level of the caller of the delivery plan processing.

On the other hand, when it is determined that the delivery schedule is determined (YES in S111), CPU 110 reads delivery data including the delivery destination of the package at the delivery base 90 from the memory 120 or the mass storage device 140 (S112). CPU 110 determines a delivery route for each of the plurality of delivery vehicles for delivering the package indicated by the read delivery data (S113).

After S113, CPU 110 determines whether the plurality of determined delivery routes include a delivery route including a regulated area 50 (low emission zone) whose emission is regulated by law (S114).

If it is determined that there is a delivery route including the regulated area 50 in which CPU 110 is a low-emission zone (YES in S114), CPU 110 assigns R13 to BEV 10 (or FCEV 20) from the delivery route R11 including the regulated area 50 in which CPU 110 is a low-emission zone (S115). CPU 110 assigns R23 from the other delivery route R21 to the remaining delivery vehicles, such as ICE vehicle 40 (or PHEV 30) (S116). Thereafter, CPU 110 returns the processing to be executed to the processing of the upper level of the caller of the delivery planning processing.

On the other hand, when it is determined that there is no delivery route including the regulated area 50 that is the low emission zone (NO in S114), CPU 110 assigns each delivery route to each delivery vehicle (S117). For example, each delivery route is assigned to each delivery vehicle so that it can be efficiently delivered according to the situation of the delivery route (specifically, it can be delivered so as to minimize the total fuel consumption or power consumption of all delivery vehicles). Thereafter, CPU 110 returns the processing to be executed to the processing of the upper level of the caller of the delivery planning processing.

Thereafter, CPU 110 controls the communication unit 130 to transmit the delivery route for which the allocation has been determined to the assigned vehicles. ECU 11, 21, 31, 41 of BEV 10, FECV 20, PHEV 30 and ICE vehicle 40 respectively deliver the delivery route received by DCM 14, 24, 34, 44 to the navigation devices 13, 23, 33, and 43. The navigation devices 13, 23, 33, and 43 navigate driving to the user or navigate autonomous driving to ECU 11,21,31,41 according to the delivered delivery route.

### Second Embodiment

In the first embodiment, each delivery route is assigned to each delivery vehicle in accordance with the presence or absence of a delivery route including the regulated area 50 that is the low emission zone. In the second embodiment, each delivery route is assigned to each delivery vehicle in accordance with the presence or absence of a delivery route including the regulated area 50 that is the low noise zone.

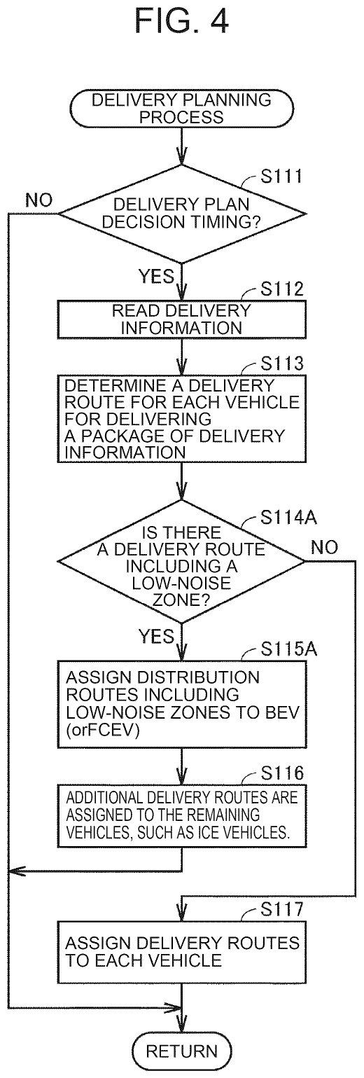

FIG. 4 is a flowchart schematically illustrating a flow of delivery plan processing executed by the delivery plan server 100 according to the second embodiment. Referring to FIG. 4, the delivery plan processing is called from the higher-level processing at predetermined intervals by CPU 110 of the delivery plan server 100 and is executed. In FIG. 4, since the processing with the same step number as that in FIG. 3 is the same as that described in FIG. 3, the overlapping description will not be repeated.

After S113 described with reference to FIG. 3, CPU 110 determines whether the plurality of determined delivery routes include a delivery route including a regulated area 50 (low noise zone) in which noise is regulated by law (S114A).

If it is determined that there is a delivery route including the regulated area 50 in which CPU 110 is in the low noise zone (YES in S114A), CPU 110 assigns R13 to BEV 10 (or FCEV 20) from the delivery route R11 including the regulated area 50 that is the low noise zone (S115A). Thereafter, CPU 110 executes the processes after S116 described with reference to FIG. 3.

On the other hand, when it is determined that there is no delivery route including the regulated area 50 that is the low noise area (NO in S114A), CPU 110 executes the processes of S117 and subsequent steps described with reference to FIG. 3.

### Third Embodiment

In the first embodiment, each delivery route is assigned to each delivery vehicle in accordance with the presence or absence of a delivery route including the regulated area 50 that is a legally defined low emission zone. In the second embodiment, each delivery route is assigned to each delivery vehicle in accordance with the presence or absence of a delivery route including the regulated area 50 that is a legally defined low noise zone. In the third embodiment, each delivery route is assigned to each delivery vehicle in accordance with the presence or absence of a delivery route including the regulated area 50, which is a residential congested area that is not clearly defined by law.

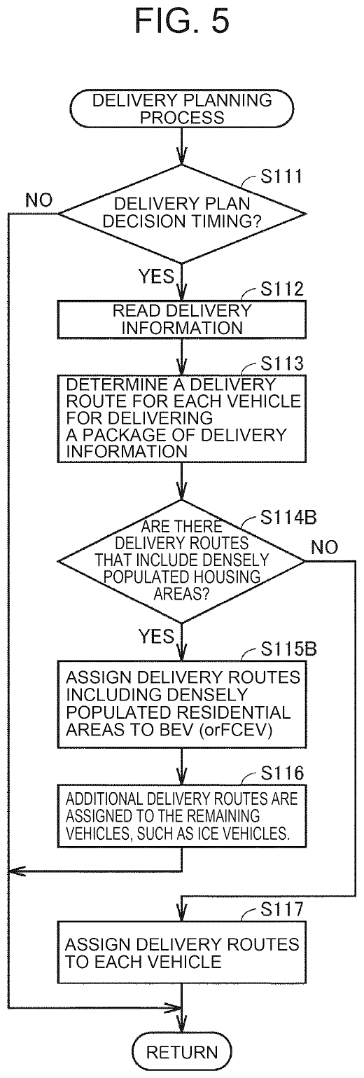

FIG. 5 is a flowchart schematically illustrating a flow of delivery plan processing executed by the delivery plan server 100 according to the third embodiment. Referring to FIG. 5, the delivery plan processing is called from the higher-level processing at predetermined intervals by CPU 110 of the delivery plan server 100 and is executed. In FIG. 5, since the processing with the same step number as that in FIG. 3 is the same as that described in FIG. 3, the overlapping description will not be repeated.

After S113 described with reference to FIG. 3, CPU 110 determines whether the plurality of determined delivery routes include a delivery route including the regulated area 50 that is a residential congested area (S114B).

If it is determined that there is a delivery route including the regulated area 50 in which CPU 110 is a residential dense area (YES in S114B), CPU 110 assigns R13 to BEV 10 (or FCEV 20) from the delivery route R11 including the regulated area 50 which is the residential dense area (S115B). Thereafter, CPU 110 executes the processes after S116 described with reference to FIG. 3.

On the other hand, when it is determined that there is no delivery route including the regulated area 50 that is the residential congested area (NO in S114B), CPU 110 executes the processes of S117 and subsequent steps described with reference to FIG. 3.

### Fourth Embodiment

In the first to third embodiments, cases where BEV 10 allocated to the delivery route including the regulated area 50 is insufficient are not considered. In the fourth embodiment, it is considered that BEV 10 allocated to the delivery route including the regulated area 50 is insufficient.

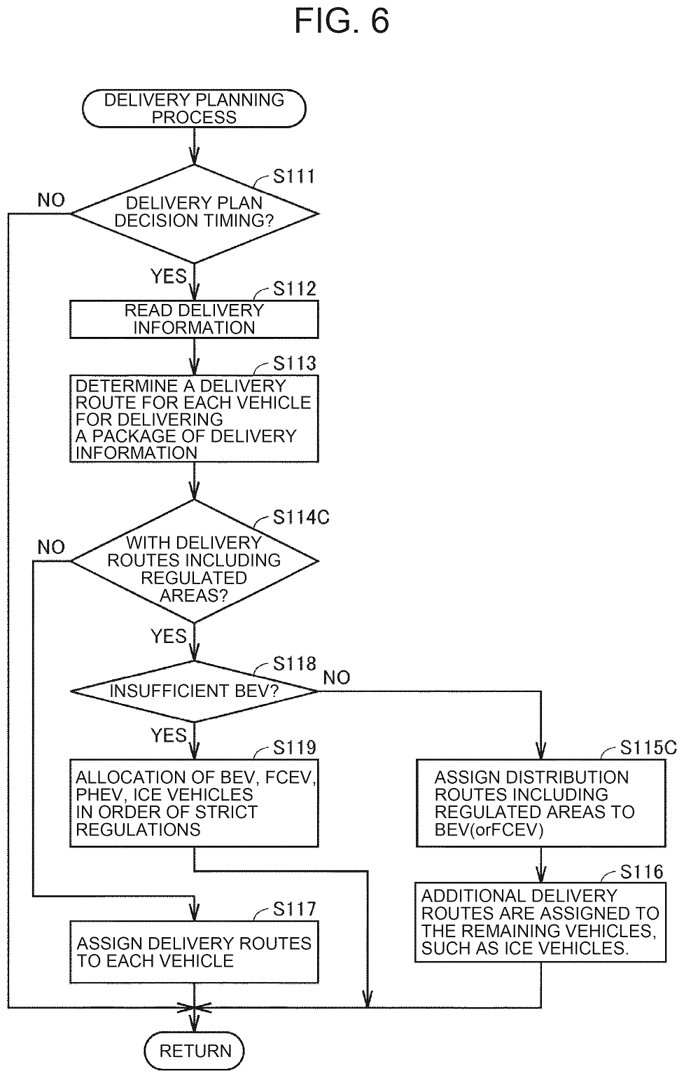

FIG. 6 is a flowchart schematically illustrating a flow of delivery plan processing executed by the delivery plan server 100 according to the fourth embodiment. Referring to FIG. 6, the delivery plan processing is called from the higher-level processing at predetermined intervals by CPU 110 of the delivery plan server 100 and is executed. In FIG. 6, since the processing with the same step number as that in FIG. 3 is the same as that described in FIG. 3, the overlapping description will not be repeated.

After S113 described with reference to FIG. 3, CPU 110 determines whether or not there is a delivery route including the regulated area 50 in the plurality of determined delivery routes (S114C). When it is determined that there is no delivery route including the regulated area 50 (NO in S114C), the processes from S117 onward described with reference to FIG. 3 are executed.

On the other hand, when it is determined that there is a delivery route including the regulated area 50 (YES in S114C), CPU 110 determines whether or not there is insufficient BEV 10 (or FCEV 20) to be allocated to the delivery route including the regulated area 50 (S118). If it is determined that BEV 10 is not insufficient (NO in S118), CPU 110 assigns R13 to BEV 10 (or FCEV 20) from the delivery route R11 including the regulated area 50 (S115C). Thereafter, CPU 110 executes the processes after S116 described with reference to FIG. 3.

On the other hand, when CPU 110 determines that BEV 10 (or FCEV 20) allocated to the delivery route including the regulated area 50 is insufficient (YES in S118), CPU 110 allocates the delivery route in the order of BEV 10, FCEV 20, PHEV 30, ICE vehicles 40 (S119). This order is the order in which the regulations of the regulated areas 50 included in the delivery route are strict. After S119, CPU 110 executes the processes after S116 described with reference to FIG. 3.

The regulatory regime of the regulated area 50 is the degree of emissions of the hazardous material per unit time, the degree of emissions of PM per unit time, the degree of emissions of CO2 per unit time, or the degree of noise magnitudes at predetermined operating conditions of the vehicles. Let x1 be the emission of hazardous materials per hour, PM emissions, or CO2 emissions limits for a regulated area 50A. In addition, it is assumed that the regulated emissions of hazardous materials, emissions of PM, or emissions of CO2 are x2 (>x1) per hour in the regulated area 50B. In this situation, since the regulation value x1 is more severe than the regulation value x2, the regulation system is more severe in the regulated area 50B than in the regulated area 50A (the regulation is more severe).

There is a regulated area 50C with the same regulatory values as the regulated area 50A with x1 regulatory values. When the section that passes through the regulated area 50A among the distribution route R1 including the regulated area 50A is y1 (km), and the section that passes through the regulated area 50C among the distribution route R2 including the regulated area 50C is y2 (>y1) (km), the section that passes through the same regulation value is longer for y2. For this reason, the distribution route R2 including the regulated area 50C is more stringent than the distribution route R1 including the regulated area 50A.

Further, in this embodiment, it is assumed that the regulated area 50C whose emission is regulated has a stricter regulating system (stricter regulating) than the regulated area 50D whose noise is regulated. A distribution route that includes a large number of regulated areas 50C with strict emission restrictions with respect to the regulated areas 50D with strict noise restrictions is more stringent than a distribution route that includes a small number of regulated areas.

### Modifications

(1) In the above-described embodiment, a hybrid electric vehicle (HEV) that does not include the power supply port 391 may be used instead of PHEV 30 or in addition to PHEV 30.
(2) The above-described embodiments can be regarded as the disclosure of the delivery planning system 1 or the delivery plan server 100, and can be regarded as the disclosure of the delivery planning method or the delivery planning program executed by the delivery planning system 1 or the delivery plan server 100.

### Summary

(1) As illustrated in FIGS. 1 and 2, the delivery plan server 100 is a device that plans delivery by a plurality of delivery vehicles, and includes a storage unit that stores delivery information including location information of delivery destinations of a plurality of packages, and a CPU 110. The plurality of delivery vehicles is, for example, BEV 10, FCEV 20, PHEV 30, ICE vehicles 40. The storage unit is, for example, a memory 120 or a mass storage device 140. As shown in FIG. 1, the delivery vehicle includes a first-type vehicle (e.g., a BEV 10, FCEV 20) and a second-type vehicle (e.g., an ICE vehicle 40, PHEV 30) that is more exhausted or noisy than the first-type vehicle. As illustrated in FIGS. 3 to 6, CPU 110 creates a plurality of delivery routes for respectively delivering a plurality of groups of packages from the position information included in the delivery information stored in the storage unit (for example, S113 from S111). CPU 110 assigns the first-type vehicles to the second-type routes including a large number of areas in which emission or noise is strictly regulated as compared with the first-type routes among the plurality of created delivery routes (for example, S115, S115A, S115B, S119). The first-type route is, for example, R23 from the delivery route R21. The second-type route is, for example, R13 from the delivery route R11.

Thus, the first-type vehicle having less exhaust gas or noise compared to the second-type vehicle is assigned to the second-type route. The second-type route includes, among the plurality of delivery routes created from the position information included in the delivery information, many areas where the exhaust gas or noise is strictly regulated as compared with the first-type route. As a result, it is possible to appropriately assign vehicles in accordance with delivery routes.
(2) As illustrated in FIGS. 3 to 6, the processor may assign (e.g., S116) the second-type vehicles to the first-type route. As a result, the second-type vehicle having a relatively large amount of exhaust gas or noise is assigned to the first-type route including a relatively small number of regions in which exhaust gas or noise is strictly regulated. As a result, it is possible to appropriately assign vehicles in accordance with delivery routes.
(3) As illustrated in FIG. 1, the second-type vehicle includes a third-type vehicle (for example, a PHEV 30) and a fourth-type vehicle (for example, an ICE vehicle 40) that is more exhausted or noisy than the third-type vehicle. As illustrated in FIG. 6, when the first-type vehicle allocated to the second-type route is insufficient, CPU110 may allocate (for example, S119) the first-type vehicle, the third-type vehicle, and the fourth-type vehicle in order from the route including a large number of regions in which emission or noise is strictly regulated among the second-type routes.

As a result, in a case where a first-type vehicle having relatively little exhaust gas or noise is insufficient, which is allocated to a second-type route including a relatively large number of areas with strict exhaust gas or noise regulations, the first-type vehicle, the third-type vehicle, and the fourth-type vehicle are allocated in order from the second-type route including a large number of areas with strict exhaust gas or noise regulations. The third-type vehicles generate more exhaust or noise than the first-type vehicles. The fourth-type vehicles generate more exhaust or noise than the third-type vehicles. As a result, it is possible to appropriately assign vehicles in accordance with delivery routes.
(4) As illustrated in FIG. 6, CPU 110 may allocate (for example, S119) the first-type vehicle, the third-type vehicle, and the fourth-type vehicle in order from the route including a large number of regions in which the emission restriction is severe to the region in which the noise restriction is severe among the second-type routes.

According to such a configuration, the first-type vehicles, the third-type vehicles, and the fourth-type vehicles are assigned in order from routes including more areas where exhaust is strictly restricted relative to areas where noise is strictly restricted from among the second-type routes. The third-type vehicles generate more exhaust or noise than the first-type vehicles. The fourth-type vehicles generate more exhaust or noise than the third-type vehicles. As a result, it is possible to appropriately assign vehicles in accordance with delivery routes.

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

1. A delivery planning apparatus that plans delivery by a plurality of vehicles, the delivery planning apparatus comprising:
a memory configured to store delivery information, the delivery information including location information of delivery destinations of a plurality of packages; and
a processor, wherein
the vehicles include first-type vehicles and second-type vehicles, each vehicle of the second-type vehicles generating more exhaust or noise than each vehicle of the first-type vehicles,
the processor is configured to:
generate a plurality of delivery routes to deliver each group of a plurality of groups of the packages based on the location information included in the delivery information stored in the memory,
acquire, from the memory, regulatory values including threshold values for regulated emission level and regulated noise level respectively associated with a plurality of regulated areas,
determine whether the generated delivery routes cover the regulated areas having the regulatory values, and
assign the first-type vehicles to second-type routes from among the generated delivery routes, the second-type routes covering larger areas of the regulated areas than first-type routes,
the second-type vehicles include third-type vehicles and fourth-type vehicles, each vehicle of the fourth-type vehicles generating more exhaust or noise than each vehicle of the third-type vehicle, and
the processor is further configured to:
assign, in an order of the first-type vehicles, the third-type vehicles, and the fourth-type vehicles, to routes that cover larger areas of the regulated areas among the second-type routes, in a case where a total number of the first-type vehicles is insufficient to be assigned to the second-type routes, and
transmit the generated delivery routes to the assigned vehicles respectively via wireless network.

2. The delivery planning apparatus according to claim 1, wherein the processor is configured to assign the second-type vehicles to the first-type routes.

3-4. (canceled)

5. A delivery planning method of a delivery planning apparatus that plans delivery by a plurality of vehicles, the delivery planning apparatus including a memory configured to store delivery information including location information of delivery destinations of a plurality of packages, and a processor, the vehicles including first-type vehicles and second-type vehicles, each vehicle of the second-type vehicles generating more exhaust or noise than each vehicle of the first-type vehicles, the second-type vehicles including third-type vehicles and fourth-type vehicles, each vehicle of the fourth-type vehicles generating more exhaust or noise than each vehicle of the third-type vehicles, the delivery planning method comprising:
generating a plurality of delivery routes to deliver each group of a plurality of groups of the packages based on the location information included in the delivery information stored in the memory;
acquiring, from the memory, regulatory values including threshold values for regulated emission level and regulated noise level respectively associated with a plurality of regulated areas,
determining whether the generated delivery routes cover the regulated areas having the regulatory values;
assigning the first-type vehicles to second-type routes from among the generated delivery routes, the second-type routes covering larger areas of the regulated areas than first-type routes;
assigning, in an order of the first-type vehicles, the third-type vehicles, and the fourth-type vehicles, to routes that cover larger areas of the regulated areas among the second-type routes, in a case where a total number of the first-type vehicles is insufficient to be assigned to the second-type routes; and
transmitting the generated delivery routes to the assigned vehicles respectively via wireless network.

6. The delivery planning apparatus according to claim 1, wherein
the first-type vehicles include battery electric vehicles and fuel cell electric vehicles,
the third-type vehicles include plug-in hybrid electric vehicles, and
the fourth-type vehicles include internal combustion engine vehicles.
